(19) United States
(12) Patent Application Publication
(10) Pub. No.: US 2008/0166818 A1
(43) Pub. Date: Jul. 10, 2008

(54) Integrated Sample Collector And Tester For Bodily Fluid

(75) Inventor: John Ennis, Vancouver, WA (US)

Correspondence Address: KAPLAN GILMAN GIBSON & DERNIER L.L.P., 900 ROUTE 9 NORTH, WOODBRIDGE, NJ, 07095, US

(73) Assignee: SALIVA DIAGNOSTIC SYSTEMS INC., Brooklyn, NY (US)

(21) Appl. No.: 11/620,960

(22) Filed: Jan. 8, 2007

(51) Int. Cl. G01N 21/77; B01J 19/00; B23P 17/00; B32B 3/10

(52) U.S. Cl. 436/164; 29/412; 422/55; 428/131

(57) ABSTRACT

In a testing kit for bodily fluids, a device is provided which combines a specimen collection component and a testing component, which are integrated into a single, inexpensive element that is readily manufactured. This permits testing by collecting a specimen with the device, then simply dropping it into a predetermined quantity of buffer solution.

### BACKGROUND OF THE INVENTION

The present invention relates generally to testers for bodily fluids and, more particularly, concerns a device which combines a sample collector with a fluid test element, a method of manufacturing the device, and a method of using the device.

Test kits for bodily fluids, including self-test kits, are widely available. For example, a typical blood testing kit includes (see FIG. 1) a test container T, a sample collector C, a dispensing bottle of sample buffer solution B. and a chemically treated test strip S. In use, the patient dispenses a measured quantity of the buffer solution Q into the test container (FIG. 1A); acquires a measured quantity of blood L from a punctured fingertip using the collector C, and deposits the blood L in the buffer solution Q, to create the test solution QL. Collector C. is then removed from container T, and a test strip S (FIG. 1C) is deposited into the test solution QL (FIG. 1D). Strip S has been chemically treated to respond to a predetermined condition of the blood. After soaking in test solution QL for a predetermined minimum time, strip Q will exhibit either a positive or negative indication for the blood condition being tested (FIG. 1D).

Unfortunately, the use of such a test kit presents a number of disadvantages. First of all, the manufacturing cost of the kit is relatively high and should be reduced, if possible. Secondly, the test procedure is relatively complex, especially for a consumer. With a distinct sequence of steps to be performed, the possibility exists that an error could be made at any one of the steps, destroying the value of the test. It would be desirable to provide a test kits which avoids these shortcomings.

### SUMMARY OF THE INVENTION

In accordance with one aspect of the present invention, the sample collector and test strip of a testing kit are integrated into a single inexpensive element, which is easily manufactured, substantially reducing the manufacturing cost of the test kit. In addition, this results in the elimination of one of the steps in using the test kit, substantially improving ease and reliability of its use.

In accordance with another aspect of the invention, a test kit is provided with a test container including a pre-measured amount of buffer solution and an element integrating a sample collector and test strip. As a result, the user need merely collect the fluid sample with the integrated element and then drop it into the buffer solution. This eliminates another step from the test procedure, providing a further improvement in ease of use and reliability. In essence, the test procedure is reduced to acquiring the sample and dropping the integrated element into the buffer solution.

In accordance with yet another aspect of the invention, a plurality of integrated collector/test-strip elements can be formed efficiently on a single sheet of material, hereafter referred to a “card”, after which the card can simply be cut to divide it into individual elements. It is also contemplated that a card may be provided in pre-divided form on a backing sheet, from which individual collector/test-strip elements may be peeled for use.

### BRIEF DESCRIPTION OF THE DRAWINGS

The foregoing brief description and further objects, features and advantages of the invention will be understood more completely from the following detailed description of presently preferred, but nonetheless illustrative, embodiments, with reference being had to the accompanying drawings, in which:

FIGS. 1(A) through 1(E), hereafter also referred to collectively as FIG. 1, are a sequence of simplified diagrams illustrating the use of a conventional test kit for body fluids;

FIG. 2 is a simplified plan view of a first embodiment of an integrated collector/test element in accordance with the present invention;

FIGS. 3(A) through 3(D), hereafter also referred to collectively as FIG. 3, are a sequence of diagrams illustrating the use of a test kit K for body fluids which incorporates the first embodiment of a collector/test element;

FIGS. 3(A) through 3(D), hereafter also referred to collectively as FIG. 3, are a sequence of simplified diagrams illustrating the use of a test kit K for body fluids which incorporates the first embodiment of a collector/test element;

FIG. 4 is a simplified diagram illustrating a test kit K′ for body fluids which incorporates the first embodiment of a collector/test element;

FIG. 5 is a plan view of a preferred sheet element or “card” utilized to manufacture first embodiment of an integrated collector/test element in accordance with the present invention;

FIG. 6 is a top plan view of an alternate embodiment of an integrated collector/test element in accordance with the present invention, this embodiment being used to collect saliva by swabbing the gums; and

FIG. 7 is left side, longitudinal sectional view of the alternate embodiment of an integrated collector/test element in accordance with the present invention.

### DETAILED DESCRIPTION OF THE PREFERRED EMBODIMENTS

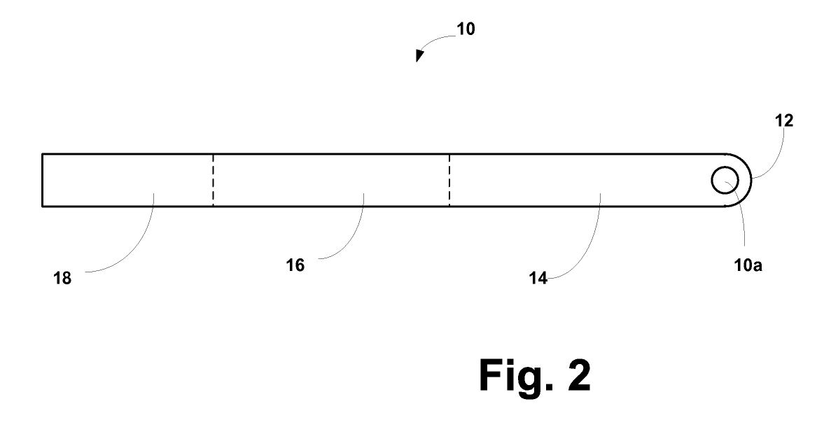

Turning now to the drawings, FIG. 2 is a plan view of the first embodiment 10 of an integrated collectors/test-strip element embodying the present invention, in this case, an element for use in blood testing. In this embodiment, element 10 is made of an elongate strip of plastic sheet material which is about 77 mm long and about 5 mm wide. At a first end 12, element 10 is provided with a through-hole 10a having about a 2 mm diameter. However, those skilled in the art will appreciate that the dimensions of element 10 and the diameter of hole 10a may be varied, as necessary for the particular application. In particular, the diameter of hole 10a may be varied to adjust the quantity of blood being collected.

A forward portion 14 of element 10, preferably about 30 mm in length, is surface treated so as to absorb test solution. Following portion 14, an intermediate portion 16, preferably about 25 mm in length, contains a nitrocelluloid membrane which is constructed to change appearance in response to a predetermined condition of the blood being tested. Following portion 16, there is a portion 18, preferably about 20 mm in length, which is constructed to act as a wick. Its function is to draw test fluid from portion 16, insuring that there is a sufficient flow of test solution through the membrane.

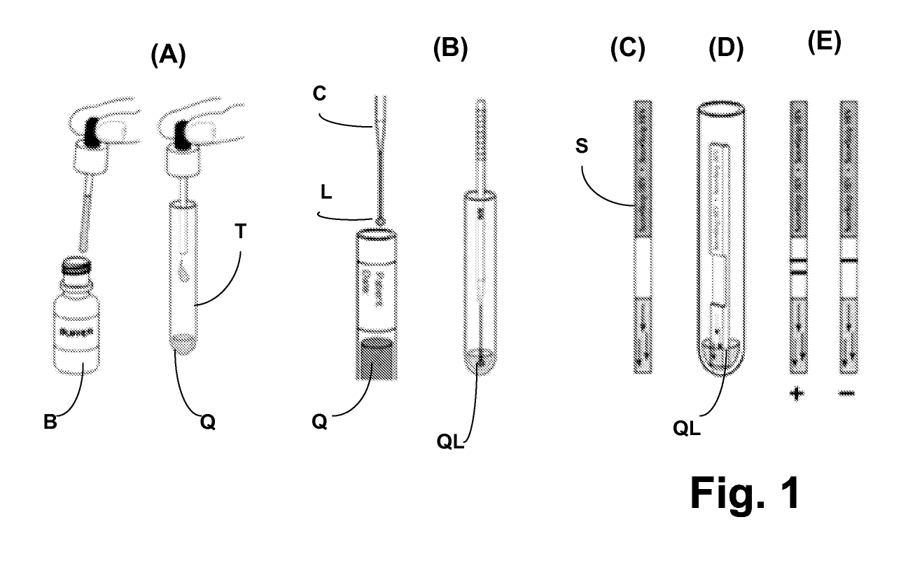

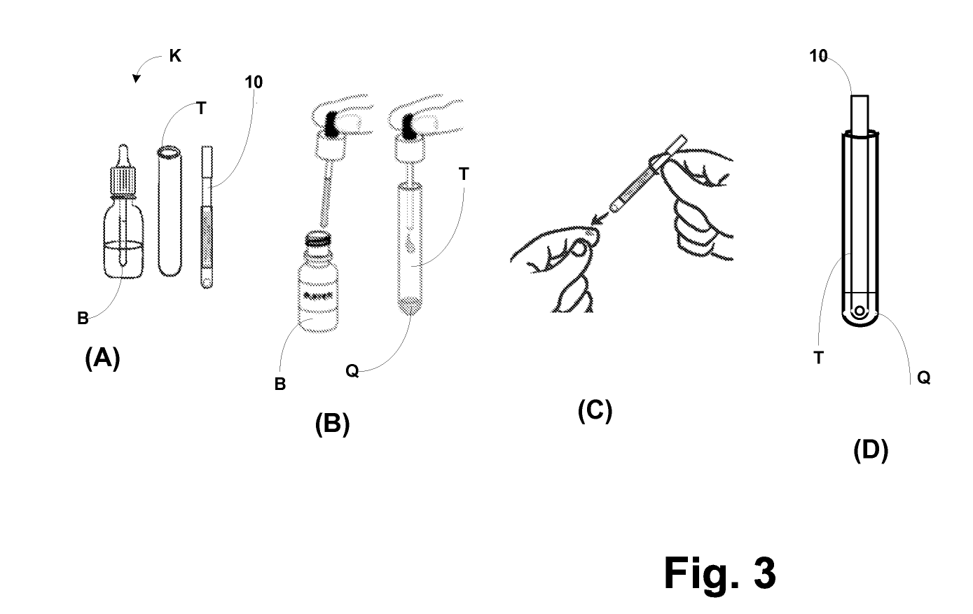

As may be seen in FIG. 3A, a test kit K incorporating integrated element 10 includes, in addition to element 10, only the bottle of buffer solution B and the test container T. Thus, the expense of the collector has been eliminated. In use of kit K, a measured quantity Q of buffer solution is first placed in container T (FIG. 3B). Element 10 is then applied to a punctured finger in order to collect a measured amount of blood within the opening 10a (FIG. 3C). Thereafter, the end of element 10 containing the blood sample is placed into the solution Q (FIG. 3D) and permitted to remain therein for a period of time calculated to produce an indication on element 10. For example, the indication might be one line or two lines (depending upon whether the indication is negative or positive), as was the case in FIG. 1E. It will to be appreciated that this procedure eliminates the step of removing the collector and replacing it with the test strip. Accordingly, it would be less likely that the user would make an error while making use of kit.

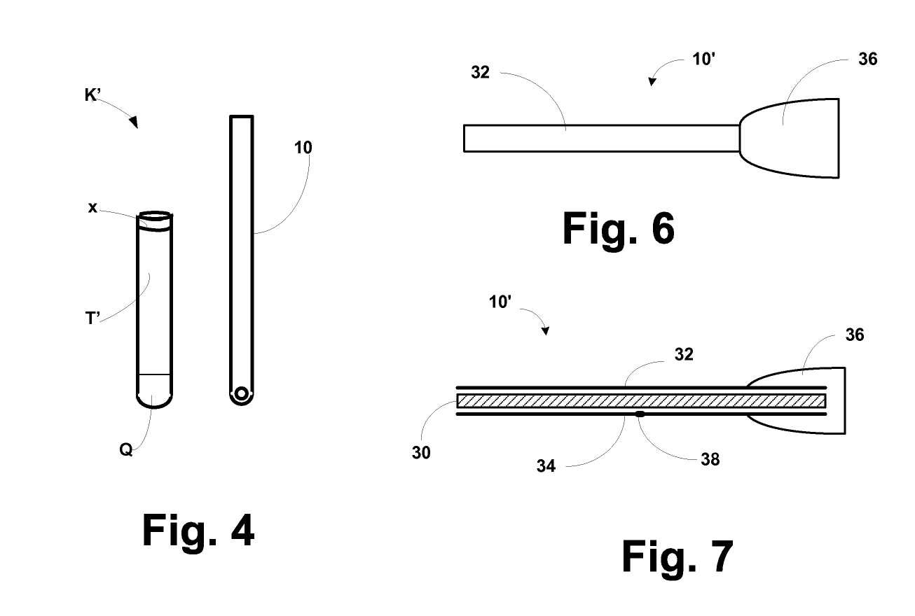

FIG. 4 illustrates an alternate embodiment K′ of a test kit incorporating integrated element 10″. This kit contains only element 10″ and a test container T′. Container T′ has been pre-filled with a predetermined quantity Q of buffer solution. In order to use kit K′, it is necessary to open container T′ by removing the closure X. A blood sample is then collected on element 10″ as illustrated in FIG. 3C, after which the element 10″ containing the blood sample is dropped into the solution into the solution Q in container T′ so that the blood sample is in the solution Q. As illustrated, element 10″ is preferably short enough to fit into container T′ with the closure applied. Element 10″ may therefore be sealed in container T′ after being dropped therein, which ensures that there is no contamination of the specimen after the test is started. It will be appreciated that kit K′, in addition to the benefit of kit K, eliminates the step of extracting a measured quantity of buffer solution and depositing it in the test container, thereby simplifying the performance of the test and substantially reducing the possibility that the user might make a mistake.

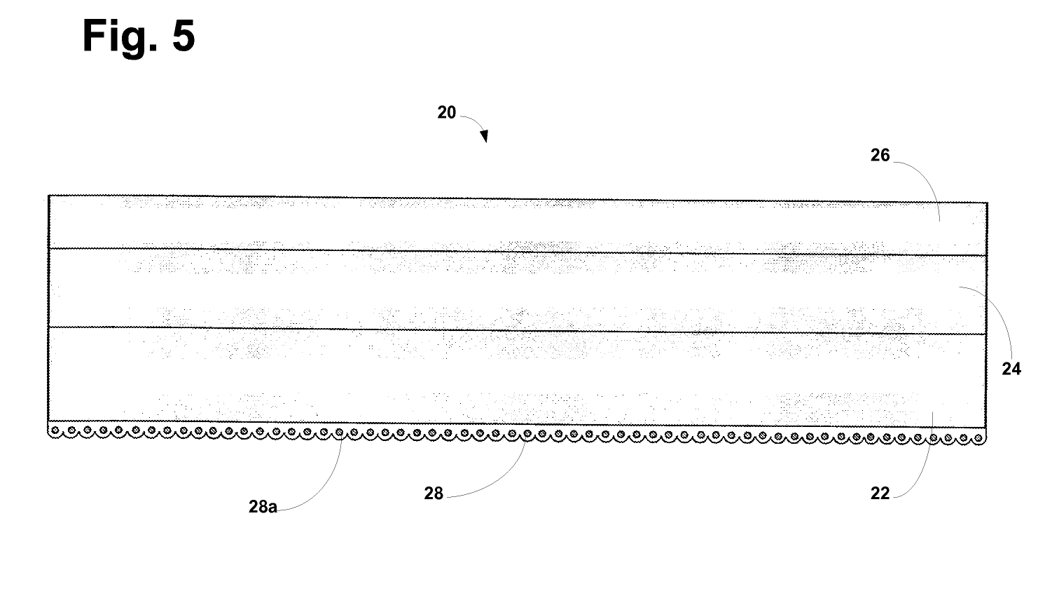

FIG. 5 is a schematic diagram illustrating a card or sheet element useful in the preferred method for manufacturing the integrated collector/test-strip element 10. A sheet of polystyrene material, preferably about 10-15 mils thick, is formed into a generally rectangular shape, preferably about 77 mm wide and about 300 mm long, to form a card 20. One of the long edges of card 20 is formed with scallops 28 that are about 5 mm wide, each scallop having a central through-hole 29a with about 2 mm diameter. A lower portion 22 of card 20 (about 30 mm in height) is treated so as to absorb the test solution, a central portion 24 of card 20 (about 30 mm in height) contains a membrane which is constructed to be responsive to a condition of a fluid to be tested, and an upper portion 22 of card 20 (about 20 mm in height) is constructed to act as a wick. The entire surface of card 20 is preferably covered with a release liner, for protection. To form an individual element 10, card 20 is cut at the end of a scallop parallel to its short edge. Those skilled in the art will appreciate that the length of card 20 may be selected to yield a desired number of elements 10. In this example, the card will yield 60 elements. It would also be possible for card 20 to be replaced by a continuous sheet so that elements 10 might be formed continuously on a cutting machine. It will be appreciated that the present method of manufacture of elements 10 is very efficient and will provide elements 10 at a substantially lower cost than has previously been possible.

It is also contemplated that elements 10 could be provided on a card 20 that has been pre-cut and mounted on a release liner. A user could then conveniently obtain elements 10, as needed, by simply peeling them from the release liner.

FIG. 6 is a plan view, and FIG. 7 is a left side sectional view of an alternate embodiment 10′ of an integrated collector/test element embodying the present invention. In this case, element 10′ is intended to be used by swabbing the gums to collect a sample of saliva. Element 10′ comprises an elongate support member 30, on the upper and lower surfaces of which are provided layers 32, 34 of sheet material. At one end of support member 30, an absorbent swab element 36 is mounted over sheet material 32, 34.

Preferably, layer 32 is constructed like element 10 of FIG. 2, except there is no is through-hole at the front end. It could therefore serve effectively as a test element for saliva, with portions 36 acting as the collection component. Sheet 34 is preferably a layer of filter paper which has been treated at a predetermined location 38 along its length so as to be visually responsive to the fluid being tested. For example, location 38 might be treated with a dye that changes color when saturated with the fluid under test. Location 38 is selected so that a sufficient test sample of the fluid under test would be present on portions 36 before enough fluid to activate the dye would migrate along the filter paper to location 38. Portion 36 is preferably made of a highly absorbent fibrous material.

In using element 10′ to collect saliva, portion 36 would be swabbed along the gums until location 38 changes color, to indicate that portion 36 is sufficiently saturated. The end of element 10′ containing portion 36 would then be submerged in a predetermined quantity of buffer solution for a predetermined period of time. That period of time would be calculated to be sufficient to permit layer 32 to respond to the test mixture of fluid under test and buffer solution. As was the case previously, layer 32 is constructed to provide a visual indication, such one line or two lines, to indicate a negative or positive test result, respectively.

Although preferred embodiments of the invention have been disclosed for illustrative purposes, those skilled in the art will appreciate that many additions, modifications and substitutions are possible without departing from the scope and spirit of the invention as defined by the accompanying claims.

What is claimed:

1. An integrated collector/test device for a body fluid, comprising a body having a first end constructed to capture and retain a quantity of the body fluid and an indicating element mounted on the body and constructed to undergo a visible change when exposed to the body fluid in a predefined condition.

2. In combination with the device of claim 1, a pre-packaged container including a predetermined quantity of buffer solution, whereby a test of the body fluid may be performed by opening the container, collecting a body fluid sample at the first end, depositing the device in the container so that the indicating element is within the buffer solution, and waiting for the indicating element to undergo a visible change.

3. The combination of claim 2, wherein the container is prepackaged with a closure and the device is dimensioned to fit within the container with the closure applied, whereby the closure may be applied after the device is deposited in the container, avoiding contamination of the test.

4. An integrated collector/test device in accordance with claim 1 wherein the body has a through-hole formed at the first end dimensioned to capture a predetermined quantity of the body fluid and the indicating element is mounted on the body so as not to be in fluid communication with the through-hole.

5. In combination with the device of claim 4, a pre-packaged container including a predetermined quantity of buffer solution, whereby a test of the body fluid may be performed by opening the container, collecting a body fluid sample in the through-hole, depositing the device in the container so that the through-hole and indicating element are within the buffer solution, and waiting for the indicating element to undergo a visible change.

6. An integrated collector/test device in accordance with claim 4, wherein the body includes a near portion near, but separated from the through-hole, constructed to be absorbent of a test solution containing the body fluid, an intermediate portion in fluid communication with the near portion and corresponding to the indicating element, and a far portion in fluid communication with the intermediate portion and constructed to be absorbent of the test solution, whereby test solution from said near portion is drawn through said intermediate portion and into said far portion.

7. In combination with the device of claim 3, a pre-packaged container including a predetermined quantity of buffer solution, whereby a test of the body fluid may be performed by opening the container, collecting a body fluid sample in the through-hole, depositing the device in the container so that the through-hole and near portion are within the buffer solution, and waiting for the indicating element to undergo a visible change.

8. An integrated collector/test device in accordance with claim 1 wherein the body has an absorbent element at the first end dimensioned to capture a quantity of the body fluid by absorbing the same, the indicating element being in fluid communication with the absorbent element.

9. In combination with the device of claim 8, a pre-packaged container including a predetermined quantity of buffer solution, whereby a test of the body fluid may be performed by opening the container, collecting body fluid in the absorbent element, depositing the device in the container so that the absorbent element is within the buffer solution, and waiting for the indicating element to undergo a visible change.

10. The combination of claim 9, wherein the container is prepackaged with a closure and the device is dimensioned to fit within the container with the closure applied, whereby the closure may be applied after the device is deposited in the container, avoiding contamination of the test.

11. An integrated collector/test device in accordance with claim 8, wherein the body includes a first sub-portion in fluid communication with the absorbent element and corresponding to the indicating element, and a second sub-portion in fluid communication with the first sub-portion and constructed to be absorbent of the test solution, whereby test solution from said absorbent element is drawn through said first sub-portion and into said second sub-portion.

12. In combination with the device of claim 11, a pre-packaged container including a predetermined quantity of buffer solution, whereby a test of the body fluid may be performed by opening the container, collecting body fluid in the absorbent element, depositing the device in the container so that the absorbent element is within the buffer solution, and waiting for the indicating element to undergo a visible change.

13. The combination of claim 12, wherein the container is prepackaged with a closure and the device is dimensioned to fit within the container with the closure applied, whereby the closure may be applied after the device is deposited in the container, avoiding contamination of the test.

14. A device in accordance with claim 12, further comprising an elongate further indicating element in fluid communication with said absorbent element and capable of absorbing a mixture of buffer solution and the bodily fluid, a marking component provided along said further indicating element at a predetermined distance from said absorbent element constructed to provide a visual indication when absorbing at least a predetermined quantity of the mixture, the predetermined distance being selected to assure that the absorbent element contains an adequate quantity of the mixture to perform a test when the marking element provides a visual indication.

15. In combination with the device of claim 14, a pre-packaged container including a predetermined quantity of buffer solution, whereby a test of the body fluid may be performed by opening the container, collecting body fluid in the absorbent element until the marking component provides a visual indication, depositing the device in the container so that the absorbent element is within the buffer solution, and waiting for the indicating element to undergo a visible change.

16. The combination of claim 15, wherein the container is prepackaged with a closure and the device is dimensioned to fit within the container with the closure applied, whereby the closure may be applied after the device is deposited in the container, avoiding contamination of the test.

17. A method for using an integrated collector/test device for a body fluid, the device including a body having a first end constructed to capture and retain a quantity of the body fluid and an indicating element mounted on the body and constructed to undergo a visible change when exposed to the body fluid in a predefined condition, the method comprising the steps of:
collecting a sample of the body fluid at the first end;
deposting the device in a predetermined quantity of buffer solution so that the sample is in the solution; and
waiting for the indicating element to provide a visual indication.

18. The method of claim 17 performed with a device in which the body has a through-hole formed at the first end dimensioned to capture a predetermined quantity of the body fluid and the indicating element is mounted on the body so as not to be in fluid communication with the through-hole, said depositing step comprising depositing the device in the container so that the through-hole and indicating element are within the buffer solution.

19. The method of claim 17 performed with a device in which the body has an absorbent element at the first end dimensioned to capture a quantity of the body fluid by absorbing the same, the indicating element being in fluid communication with the absorbent element, said depositing step comprising depositing the device in the container so that only the absorbent element is within the buffer solution.

20. The method of claim 19 performed with a device including an elongate further indicating element in fluid communication with said absorbent element and capable of absorbing a mixture of buffer solution and the bodily fluid, and a marking component provided along said further indicating element constructed to provide a visual indication when absorbing at least a predetermined quantity of the mixture, said collecting step comprising collecting the bodily fluid until the marking component provides a visual indication.

21. The method of claim 17, wherein the buffer solution is provided in a container having a closure, the device being dimensioned to fit within the container with the closure applied, the method further comprising, after said depositing step, applying the closure to the container to avoid contamination of the test.

22. A master form useful for the manufacture of integrated collector/test devices for a body fluid, comprising a main body made of a sheet material having a length dimension and a width dimension, a plurality of through-holes formed in the body so as to extend along the length dimension an area on said body spaced from the through-holes and constructed to undergo a visible change when exposed to the body fluid in a predefined condition, a device being created by cutting a strip from the master form so as to include a through-hole and a portion of the area.

23. A master form as in claim 22 which has been cut into a plurality of strips, each including a through-hole and a portion of the area, further comprising a backing sheet to which the strips are removeably mounted, a device being obtained by separating one of the strips from the backing sheet.

24. A method for manufacturing an integrated collector/test device for a body fluid, said method making use of a master form including a main body made of a sheet material having a length dimension and a width dimension, a plurality of through-holes formed in the body so as to extend along the length dimension an area on said body spaced from the through-holes and constructed to undergo a visible change when exposed to the body fluid in a predefined condition, said method comprising the step of cutting a strip from the master form so as to include a through-hole and a portion of the area.

25. A method for creating a dispensable set of integrated collector/test device for a body fluid, said method making use of a master form including a main body made of a sheet material having a length dimension and a width dimension, a plurality of through-holes formed in the body so as to extend along the length dimension an area on said body spaced from the through-holes and constructed to undergo a visible change when exposed to the body fluid in a predefined condition, said method comprising the steps of:
cutting a plurality of strips from the master form so that each includes a through-hole and a portion of the area;
removeably mounting the plurality of strips on a backing sheet;
a device being dispensed by separating one of the strips from the backing sheet.
